(19) United States
(12) Patent Application Publication
(10) Pub. No.: US 2026/0116641 A1
(43) Pub. Date: Apr. 30, 2026

(54) PACKAGING CUSHION FOR HOUSEHOLD APPLIANCE, HOUSEHOLD APPLIANCE, AND METHOD FOR MANUFACTURING PACKAGING CUSHION

(71) Applicant: BSH Hausgeräte GmbH, München (DE)

(72) Inventors: Yunyu LONG, Chuzhou (CN); Chuanqiang SHI, Chuzhou (CN); Chun HU, Nanjing (CN); Chao ZHU, Chuzhou (CN); Chunhao LIU, Chuzhou (CN)

(21) Appl. No.: 19/370,996

(22) Filed: Oct. 28, 2025

(30) Foreign Application Priority Data
Oct. 31, 2024 (CN) 202411556052.7

(51) Int. Cl. B65D 81/05; B31D 5/00; B65D 81/02; B65D 85/68; F25D 23/08

(52) U.S. Cl. CPC B65D 81/058; B31D 5/0039; B65D 65/44; B65D 85/68; F25D 23/08; B31D 2205/0064; B65D 2581/053; B65D 2585/6817

(57) ABSTRACT

A household appliance includes a main body defining a chamber and a door configured to close the chamber. A packaging cushion wraps a top or a bottom of the household appliance. The packaging cushion includes: a first plate, at least configured to cover a top surface or a bottom surface of the main body, a rim on at least one side of the first plate being folded to form a side portion provided with a cavity, and the side portion being configured to cover at least part of a side surface of the main body. A protective member is disposed in the cavity. The packaging solution is environmentally friendly, efficient, and reliable.

### CROSS-REFERENCE TO RELATED APPLICATION

This application claims the priority, under 35 U.S.C. § 119, of Chinese Patent Application CN 202411556052.7, filed Oct. 31, 2024; the prior application is herewith incorporated by reference in its entirety.

### FIELD AND BACKGROUND OF THE INVENTION

Embodiments of the present disclosure relate to the field of household appliance technologies, and specifically, to a packaging cushion for a household appliance, a household appliance, and a method for manufacturing a packaging cushion.

### BACKGROUND

During transportation, a household appliance is usually additionally packaged and protected on the outside to avoid damage caused by impact on the external surface of the household appliance during handling.

At present, during the handling of a household appliance, a top cover (and/or a bottom cushion) made of an expanded polystyrene board (EPS for short) material is usually used to protect a periphery of a top (and/or a periphery of a bottom) of the household appliance. However, the EPS material is not environmentally friendly, foam particles may fall down during transportation, and it is difficult to recycle and process an EPS foam top cover, which requires hundreds of years to decompose, causing environmental pollution problems. On the other hand, the protection for the top and/or the bottom of the household appliance by the existing EPS foam top cover is concentrated on the top surface and/or the bottom surface, and the protection for the side surface of the household appliance close to the top and/or the bottom is relatively weak.

### SUMMARY OF THE INVENTION

An objective of embodiments of the present disclosure is to provide an improved packaging solution for a household appliance.

Therefore, the embodiments of the present disclosure provide a packaging cushion for a household appliance. The household appliance includes a main body defining a chamber and a door configured to close the chamber. The packaging cushion wraps a top or a bottom of the household appliance. The packaging cushion includes: a first plate, at least configured to cover a top surface or a bottom surface of the main body, a rim on at least one side of the first plate being folded to form a side portion provided with a cavity, and the side portion being configured to cover at least part of a side surface of the main body; and a protective member disposed in the cavity.

Compared with an existing packaging solution using EPS, in this implementation solution, the top surface or the bottom surface of the household appliance is protected by the first plate, and the side portion provides targeted protection for the side surface of the household appliance close to the top or the bottom, which is beneficial to more reliable protection of the household appliance. When the household appliance is inclined during handling, the cooperation of the side portion and the first plate can protect corners and edges of the top or the bottom of the household appliance in an all-round way, thereby better preventing the household appliance from impact and damage. Further, the side portion is formed by folding of the flange of the first plate, that is, the side portion and the first plate are the same member, so that the packaging cushion has a small quantity of parts and is easy to manufacture and assemble. Further, the cavity of the side portion is prevented from springing back and deformation in the manner of filling the protective member, to ensure flat crush strength of the overall structure of the flange, thereby effectively protecting the periphery of the top or the bottom of the household appliance.

Optionally, the side portion extends at least partially around the first plate. Therefore, at least part of the periphery of the top or the bottom of the household appliance can be reliably protected.

Optionally, the rim on the at least one side of the first plate first extends along a first direction and then extends back to the first plate to form the cavity, a non-zero angle being formed between the first direction and a plane in which the first plate is located. Therefore, the first plate is self-folded to form the side portion, and an integral design is beneficial to reducing an assembly error and simplifying an assembly process. Further, the design of the cavity enables the side portion to have a particular thickness, so that when being impacted by an external force, the side portion can serve the functions of cushioning and shock absorption, thereby better protecting the side surface of the household appliance.

Optionally, the protective member and the first plate are separately made of paper materials of different structures. Therefore, manufacturing of the packaging cushion using paper is beneficial to environmental protection while effectively protecting the top or the bottom of the household appliance. Further, the characteristic of the paper material enables the side portion to be more easily folded and formed, thereby reducing processing difficulty of the packaging cushion and facilitating manufacturing. Further, the protective member and the first plate are separately manufactured using more suitable paper materials, and can better achieve the functions of the components. For example, the first plate is manufactured using an easily foldable paper material to facilitate the formation of the side portion, and a high-strength paper material is used as the protective member to fill the cavity to increase the flat crush strength of the side portion, thereby preventing the side portion from being crushed and deformed when being impacted by an external force.

Optionally, strength of the protective member is greater than strength of the first plate. Therefore, the flat crush strength of the overall structure of the flange is ensured, thereby protecting the periphery of the top or the bottom of the household appliance more effectively.

Optionally, rigidity of the protective member is greater than rigidity of the first plate. Therefore, the side portion is less vulnerable to compression and deformation under the strengthening of the protective member, thereby better protecting the side surface of the household appliance.

Optionally, compressive resistance of the protective member is greater than compressive resistance of the first plate. Therefore, the side portion is not easily deformed when being pressed, thereby ensuring that the side surface of the household appliance is always reliably protected.

Optionally, a thickness of the protective member is greater than a thickness of the first plate. Therefore, the protective member having a large thickness ensures that the side portion is sufficiently thick to obtain good compressive resistance. Further, the first plate should not have an excessively large thickness to ensure sufficient protection for the top surface or the bottom surface, thereby facilitating folding to form the side portion.

Optionally, the side portion includes a first wall and a second wall that are opposite to each other and a third wall located between the first wall and the second wall, the first wall is connected to the first plate, an edge of the second wall is positioned at the first plate, and the protective member at least fills a space between the first wall and the second wall. Therefore, the protective member fills at least a space between the initial segment (that is, the first wall) and the tail segment (that is, the second wall) of the flange of the first plate, to avoid deformation of the side portion due to warping of the tail segment, thereby ensuring the reliability of protection for the side surface by the side portion.

Optionally, an assembly hole is opened in the first plate, an assembly portion is disposed at the edge of the second wall, and the assembly portion is configured to cooperate with the assembly hole to position the second wall to the first plate. Therefore, no additional fixing member is required, the first plate is synchronously positioned when the rim of the first plate is folded to form the side portion, and the process of forming the entire side portion is simple and efficient.

Optionally, the packaging cushion further includes: a support plate, covering a face of the first plate that faces the top surface or the bottom surface of the main body, and the second wall being partially sandwiched between the support plate and the protective member. In a direction from the center of the first plate to the outside in a plane perpendicular to a height direction of the household appliance, the support plate and the protective member cooperatively clamp the second wall from two sides, to prevent a positioning failure between an edge of the second wall and the first plate, and prevent deformation of the side portion caused by unexpected springback of the rim of the first plate that forms the side portion. Therefore, the flange forming the side portion is prevented from springback and deformation through filling and support, thereby ensuring that the side portion can effectively protect the periphery of the top or the bottom of the household appliance all the time.

Optionally, an avoidance groove open toward a center of the first plate is opened in the side portion and is configured to avoid a component located at the top or the bottom of the household appliance, and the protective member is disconnected at the avoidance groove. Therefore, the design of the avoidance groove ensures that the packaging cushion does not interfere with inherent components of the household appliance while providing reliable protection.

Optionally, a non-zero gap is formed between the avoidance groove and the edge of the second wall. Therefore, the avoidance groove does not interrupt the tail segment of the side portion, that is, the second wall provided with the avoidance groove is still continuous end-to-end at the edge, so that the effect of preventing the side portion from warping is better. Specifically, even if positioning of the edge of the second wall between the partial section and the first plate fails, the second wall may be roughly locked in place in cooperation with positioning of the other sections at the edge and the first plate, and the flange of the first plate that forms the side portion is not prone to springback and deformation.

Optionally, the avoidance groove appears as a closed figure. Therefore, the avoidance groove is not opened to the bottom, and the edge of the second wall forms a boundary on a side of the avoidance groove, thereby helping prevent the flange of the side portion from springback and deformation.

Optionally, the avoidance groove is partially located in the second wall and partially located in the third wall. Therefore, the avoidance groove provides an avoidance space in a thickness direction of the side portion, thereby avoiding a component at the top or the bottom of the household appliance more effectively.

Optionally, the avoidance groove is formed by a hollowed-out hole opened in the rim on the side of the first plate when the rim is folded to form the side portion. Therefore, the avoidance groove is formed at the same time when the side portion is formed, thereby improving the manufacturing efficiency.

Optionally, a rim on a side of the first plate corresponding to the door is folded to form a blocking portion, and the blocking portion covers part of a front surface of the door. Therefore, the side portion and the blocking portion cooperate to better protect the periphery of the top or the bottom of the household appliance.

Optionally, a void is formed inside the blocking portion, and a width of the void is less than a width of the cavity. A smaller void of the blocking portion is better, which helps increase the strength and/or the rigidity and/or the compressive resistance of the blocking portion. Further, the blocking portion having a small void can minimize the dimension of a refrigeration appliance in a packaged state in a depth direction based on the protection of the front surface of the door.

Optionally, a distance between the top surface of the main body and the first plate is greater than a distance between an upper surface of the door and the first plate. Therefore, the door is closer to the first plate, that is, compared with a large distance between the main body and the connection between the side portion and the first plate, the door is closer to the connection between the blocking portion and the first plate. Further, the door itself may be used to abut against the blocking portion to prevent the door from springback and deformation.

Optionally, a distance between the bottom surface of the main body and the first plate is greater than a distance between a lower surface of the door and the first plate. Therefore, the door is closer to the first plate, that is, compared with a large distance between the main body and the connection between the side portion and the first plate, the door is closer to the connection between the blocking portion and the first plate. Further, the door itself may be used to abut against the blocking portion to prevent the door from springback and deformation.

Optionally, the blocking portion forms a double-layer protective structure on the front surface of the door. Therefore, the blocking portion has better rigidity, strength, and compressive resistance, and can protect the front surface of the door more reliably.

Optionally, the packaging cushion further includes: a support plate, filling a region of the first plate that is surrounded by the side portion. Therefore, the overall structural strength of the packaging cushion is enhanced, thereby better protecting the top surface or the bottom surface.

Optionally, the support plate abuts against the side portion in a circumferential direction to be limited to the side portion. Therefore, the support plate fills up the space enclosed by the side portion and cooperates with the side portion to implement positioning, so that auxiliary measures (for example, an adhesive tape) do not need to be used to fix the support plate and the side portion, so that the packaging cushion is environmentally friendly and has a more simplified manufacturing process.

Optionally, strength of the support plate is greater than strength of the first plate. Therefore, the flat crush strength of the region of the packaging cushion corresponding to the top surface or the bottom surface is improved, so that the top or the bottom of the household appliance can be better protected.

Optionally, rigidity of the support plate is greater than rigidity of the first plate. Therefore, the region of the packaging cushion corresponding to the top surface or the bottom surface is not prone to deformation under pressure, thereby better protecting the top or the bottom of the household appliance.

Optionally, compressive resistance of the support plate is greater than compressive resistance of the first plate. Therefore, the compressive resistance of the top or the bottom of the household appliance in a packaged state is enhanced.

Optionally, a thickness of the support plate is greater than a thickness of the first plate. Therefore, the strength and the compressive resistance of the region of the packaging cushion corresponding to the top surface or the bottom surface are enhanced. Further, the combined thickness of the support plate and the first plate can increase the contact area with the side plate, so that the clamping and positioning effect on the second wall in cooperation with the protective member is more prominent.

Optionally, the support plate includes a second plate and a third plate sequentially arranged along a direction perpendicular to the first plate, the second plate is located between the third plate and the first plate, the second plate fills up the region of the first plate that is surrounded by the side portion, and the third plate fills a gap between the top surface of the main body and the first plate or fills a gap between the bottom surface of the main body and the first plate. Therefore, the support plate is further divided into the second plate and the third plate. The second plate preferably fills up the entire space enclosed by the side portion without considering the specific shape of the top surface or the bottom surface (for example, whether the surface is bumpy due to the arrangement of components). On one hand, the strength/rigidity/compressive resistance of different positions of the first plate can be enhanced, and on the other hand, the flange forming the side portions can also be prevented from springback and deformation. Further, the third plate is designed according to the specific shape of the top surface or the bottom surface to fill in the void between the top surface or the bottom surface and the second plate. The third plate itself has a particular thickness to further stop the springback of the flange. On the other hand, the combination of the thicknesses of the third plate, the second plate, and the first plate is conducive to further increasing the flat crush strength of the packaging cushion, thereby better protecting the top surface or the bottom surface.

Optionally, the top surface or the bottom surface of the main body is provided with a protrusion structure protruding outward, the second plate covers the protrusion structure, and the third plate forms a notch corresponding to the protrusion structure. Therefore, the second plate and the first plate jointly protect the entire top surface or bottom surface, and the third plate avoids the protrusion structure while further improving the protection performance, thereby ensuring that the packaging cushion can smoothly wrap the top or the bottom of the household appliance.

Optionally, strength of the third plate is greater than strength of the second plate. Therefore, the flat crush strength of the region of the packaging cushion corresponding to the top surface or the bottom surface is improved, so that the top or the bottom of the household appliance can be better protected.

Optionally, rigidity of the third plate is greater than rigidity of the second plate. Therefore, the region of the packaging cushion corresponding to the top surface or the bottom surface is not prone to deformation under pressure, thereby better protecting the top or the bottom of the household appliance.

Optionally, compressive resistance of the third plate is greater than compressive resistance of the second plate. Therefore, the compressive resistance of the top or the bottom of the household appliance in a packaged state is enhanced.

Optionally, a thickness of the third plate is greater than a thickness of the second plate. The second plate mainly serves the functions of assisting in strength improvement and preventing springback of the flange forming the side portion, and therefore has a relatively low requirement on the thickness. The third plate is configured to fill the gap between the second plate and the top surface (or the bottom surface), and has a higher requirement on the thickness. Therefore, through the coordination of the second plate having a small thickness and the third plate having a large thickness, the overall height of the household appliance in the packaged state is reduced while the effect of protecting the top surface or the bottom surface is ensured, thereby facilitating handling.

Optionally, the second plate is made of corrugated board. Therefore, the second plate, the first plate, and the protective member are all made of paper, and are environmentally friendly.

Optionally, the third plate is made of honeycomb board. Therefore, the third plate is made of honeycomb board having better strength, thereby further enhancing the effect of protecting the top or the bottom of the household appliance.

Optionally, the first plate is made of corrugated board. Optionally, the protective member is made of honeycomb board. Therefore, easy formability, easy foldability, and puncture resistance functions of the corrugated board are fully applied together with the honeycomb board having high flat crush strength, so that the manufactured packaging cushion is aesthetically pleasing and environmentally friendly, and can effectively protect the top or the bottom of the household appliance.

Optionally, a cross section of the cavity is rectangular. The overall structure of the side portion having the rectangular cavity is more stable, and the protective member cooperatively inserted in the cavity can reliably protect the side surface of the household appliance, so that the side portion is not prone to deformation when being impacted by an external force.

Therefore, the embodiments of the present disclosure further provide a household appliance, being in a packaged state, including: a main body, defining a chamber; and a door, configured to close the chamber, characterized in that the household appliance further includes: the foregoing packaging cushion, where the first plate covers at least a top surface or a bottom surface of the main body, and the side portion covers part of a side surface of the main body. Therefore, the packaging cushion can protect the periphery of the top or the bottom of the household appliance more reliably. Specifically, when the household appliance in the packaged state is inclined during handling, the cooperation of the side portion and the first plate of the packaging cushion can protect corners and edges of the top or the bottom of the household appliance in an all-round way, thereby better preventing the household appliance from impact and damage.

Therefore, the embodiments of the present disclosure further provide a method for manufacturing a packaging cushion. The packaging cushion is configured to wrap a top or a bottom of a household appliance. The manufacturing method includes: providing a first plate; fixing a protective member to a rim on at least one side of the first plate; and folding the rim on the at least one side to form a side portion, the protective member being wrapped in a cavity enclosed by the side portion. Therefore, the manufacturing process of the packaging cushion is simple, and production line production is more efficient. Specifically, the protective member is folded together with the rim of the first plate, so that the action of inserting the protective member into the cavity is completed while the side portion is formed. Compared with the manufacturing process of first forming the side portion through folding and then inserting the protective member, the manufacturing process of this implementation solution involves fewer steps and achieves higher efficiency.

Optionally, the fixing a protective member to a rim on at least one side of the first plate includes: fixing the protective member to the rim on the at least one side against an edge of the first plate. Therefore, before the rim of the first plate is folded, the protective member is fixed to a predetermined position of the first plate. During the folding, the protective member can further play a positioning and guiding function, thereby facilitating quick and accurate folding to form the side portion.

Optionally, the protective member includes a first face fixed to the rim, an opposite third face, a second face located between the first face and the third face and away from the edge of the first plate, and an opposite fourth face, and the folding the rim on the at least one side to form a side portion includes: folding the rim on the at least one side and the protective member fixed to the rim from the edge of the first plate toward a center of the first plate until the second face contacts the first plate; continuing to fold the rim on the at least one side toward the center of the first plate until the third face contacts the first plate; continuing to fold the rim on the at least one side toward the center of the first plate until the fourth face contacts the first plate; and positioning the edge of the first plate to the first plate to form the side portion filled with the protective member. Therefore, the shape of the cavity in the side portion formed by folding matches the shape of the outer contour of the protective member, so that the protective member can fill the cavity sufficiently, thereby effectively preventing the edge of the first plate from springback and deformation.

Other features which are considered as characteristic for the invention are set forth in the appended claims.

Although the invention is illustrated and described herein as embodied in a packaging cushion for a household appliance, a household appliance, and a method for manufacturing packaging cushion, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, perspective view of a household appliance in a packaged state according to an embodiment of the invention;

FIG. 2 is an perspective of a packaging cushion shown in FIG. 1 from another viewing angle;

FIG. 3 is an exploded, perspective view of the packaging cushion shown in FIG. 2;

FIG. 4 is a front view of the packaging cushion in FIG. 1;

FIG. 5 is a cross-sectional view taken along the line V-V shown in FIG. 4;

FIG. 6 is a cross-sectional view taken along the line VI-VI shown in FIG. 1;

FIG. 7 is a partial, sectional view of a region VII shown in FIG. 6;

FIG. 8 is a partial, section view of a region VIII shown in FIG. 6; and

FIG. 9 and FIG. 10 are schematic diagrams of a manufacturing process of a packaging cushion according to an embodiment of the present disclosure.

### DETAILED DESCRIPTION OF THE INVENTION

To make the foregoing objectives, features, and advantages of the present disclosure more comprehensible, specific embodiments of the present disclosure are described in detail below with reference to the accompanying drawings.

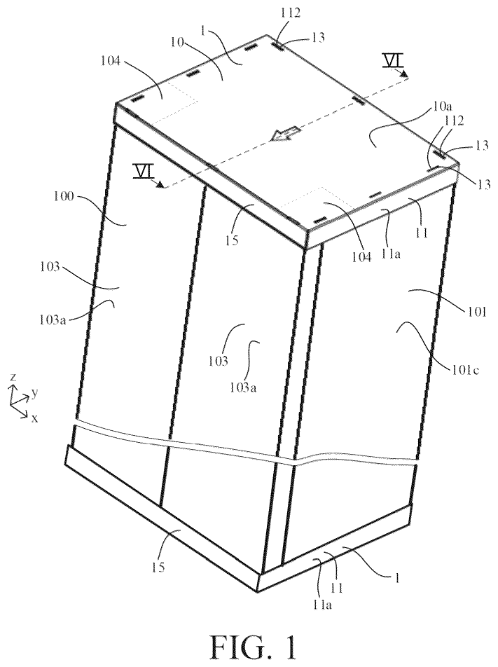

Referring now to the figures of the drawings in detail and first, particularly to FIG. 1 thereof, there is shown a household appliance 100 in a packaged state according to an embodiment of the present disclosure.

The household appliance 100 may be a refrigeration appliance, a washing machine, a dishwasher, an oven, or the like. The refrigeration appliance may be a refrigerator, a freezer, a wine cooler, or the like. FIG. 1 is exemplarily shown by using a refrigerator as an example. This implementation solution may be applied to single-door refrigerators, various forms of refrigerators with left and right doors such as cross-door refrigerators, French-door refrigerators, and side-by-side refrigerators, three-door refrigerators, and the like.

For ease of description, in this implementation solution, a width direction of the household appliance 100 is denoted as an x direction, a depth direction of the household appliance 100 is denoted as a y direction, and a height direction of the household appliance 100 is denoted as a z direction. In this implementation solution, a front-rear direction refers to the y direction and an opposite direction of the y direction, where the front or a front side refers to a direction that faces a user when the household appliance 100 is in use, and the rear or a rear side refers to a direction that faces away from the user when the household appliance 100 is in use. In this implementation solution, an up-down direction refers to the z direction and a direction opposite to the z direction, where above or an upper side or the top refers to a direction that is more up along a gravity direction when the household appliance 100 is in use, and below or a lower side or the bottom refers to a direction that the household appliance 100 contacts or is closest to the ground during use.

The household appliance 100 in this embodiment is in a packaged state. Specifically, during handling of the household appliance 100, a protective housing is usually wrapped around the household appliance 100 to provide anti-collision and cushioning functions. Some accessories configured for the household appliance 100 may also be disassembled from installation positions of the accessories and placed in dedicated boxes, to facilitate transportation. The household appliance 100 in the packaged state cannot be directly used. After being transported to a suitable location (for example, a user's home), the protective housing is disassembled, the accessories are taken out from the boxes and installed back to the corresponding installation positions, and the household appliance 100 may enter a use state for a user to use.

Specifically, referring to FIG. 1, the household appliance 100 may include a main body 101 defining a chamber 102 and a door 103. The door 103 is movably connected to the front of the main body 101 to open or close at least part of the chamber 102. A refrigerator is used as an example. The chamber 102 may be a freezer compartment, a refrigerator compartment, a convertible compartment, or the like. FIG. 1 exemplarily shows one chamber 102, for example, a refrigerator compartment.

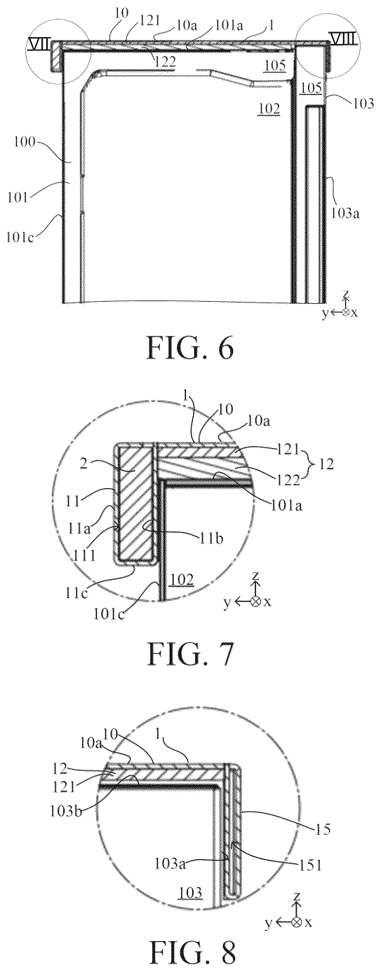

Further, the main body 101 may include a top surface 101a and a bottom surface (not shown in the figure) that are opposite in the z direction and a side surface located between the top surface 101a and the bottom surface. For example, the side surface may include a pair of sidewalls opposite to each other in the x direction and a rear wall located on a rear side in the y direction. A refrigerator is used as an example. Referring to FIG. 1 and FIG. 6, a thermal insulation space 105 filled with a thermal insulation material is included between a space that is jointly enclosed by the top surface 101a, the bottom surface, and the side surface 101c and that is open forward and the chamber 102 provided in the space. A thermal insulation layer formed by the thermal insulation space 105 has the effect of isolating heat to ensure that the chamber 102 has a good refrigeration/freezing effect.

Further, the door 103 may also include the thermal insulation space 105 filled with a thermal insulation material. When the door 103 closes the chamber 102, the thermal insulation layer formed by the thermal insulation space 105 has the effect of isolating heat to ensure that the chamber 102 has a good refrigeration/freezing effect. The door 103 may include a front panel, a rear wall facing the main body 101 when the door 103 is closed, and frame disposed along a periphery of the door 103. The front panel forms a front surface 103a of the door 103, and a pair of frames opposite to each other in the z direction respectively form an upper surface 103b and a lower surface (not shown) of the door 103. The thermal insulation space 105 is located between the front panel and the rear wall. In some embodiments, the front panel forms at least part of a front boundary of the thermal insulation space 105, so that the thermal insulation material is in contact with a rear side of the front panel. In some other embodiments, another door panel may be further disposed on the rear side of the front panel. The front panel may be a glass panel or a ceramic panel.

Further, referring to FIG. 1, the household appliance 100 in the packaged state is wrapped with a packaging cushion 1 at least at the top and/or the bottom, to protect the top and/or the bottom of the household appliance 100. In some embodiments, the packaging cushion 1 may be made of a paper material, and is environmentally friendly.

Further, referring to FIG. 1 to FIG. 4, the packaging cushion 1 may include a first plate 10, at least configured to cover the top surface 101a or the bottom surface of the main body 101. In response to that the packaging cushion 1 wraps the top of the household appliance 100, the first plate 10 covers at least the top surface 101a of the main body 101. Further, the first plate 10 may further cover the upper surface 103b of the door 103 (as shown in FIG. 6). In response to that the packaging cushion 1 wraps the bottom of the household appliance 100, the first plate 10 covers at least the bottom surface of the main body 101. Further, the first plate 10 may further cover the lower surface of the door 103. Next, unless otherwise specified, the structure of the packaging cushion 1 is specifically described by using an example in which the packaging cushion 1 wraps the top of the household appliance 100, and the structure of the packaging cushion 1 disposed at the bottom of the household appliance 100 is vertically symmetrical with respect to the structure of the packaging cushion 1 located at the top using a horizontal direction as an axis.

The first plate 10 may have a plate shape and cover the top surface 101a, and the first plate 10 is approximately rectangular. During actual application, the shape of the first plate 10 may alternatively be adaptively designed based on the shape of the top of the household appliance 100.

Further, a rim on at least one side of the first plate 10 is folded to form a side portion 11 provided with a cavity 111, and the side portion 11 is configured to cover at least part of the side surface 101c of the main body 101. A part of the first plate 10 that forms the side portion 11 is denoted as a flange. The first plate 10 may include a first surface 10a and a second surface 10b that are opposite to each other. When the packaging cushion 1 wraps the top of the household appliance 100, the first surface 10a faces away from the top surface 101a, the second surface 10b faces the top surface 101a, and the side portion 11 may extend from the second surface 10b in a direction away from the first surface 10a. In other words, when the packaging cushion 1 wraps the top of the household appliance 100, projections of the side portion 11 in the y direction and/or the x direction at least partially overlap the side surface 101c of the household appliance 100. The cover-like structure jointly formed by the first plate 10 and the side portion 11 covers regions of the top surface 101a and the side surface 101c close to the top of the household appliance 100. For example, rims of the first plate 10 corresponding to three side surfaces 101c of the main body 101 are folded to form the side portion 11. Therefore, the packaging cushion 1 protects each side surface 101c of the main body 101.

Further, a cross section of the cavity 111 may be rectangular (as shown in FIG. 5 and FIG. 7). The overall structure of the side portion 11 having the rectangular cavity 111 is more stable. The side portion 11 may be easily joined to the side surface 101c of the household appliance 100. The protective member 2 cooperatively inserted in the cavity 111 can reliably protect the side surface 101c of the household appliance 100, so that the side portion is not prone to deformation when being impacted by an external force. During actual application, the cross section of the cavity 111 may alternatively be a triangle, a trapezoid, or the like, provided that a structure with two layers that are not joined is formed on the outer side of the side surface 101c.

Further, the packaging cushion 1 may further include a protective member 2 that is filled in the cavity 111. The shape of the protective member 2 may match the shape of the cavity 111 to fill up the space of the cavity 111 as much as possible. Filling up means that gaps between the protective member 2 and the walls of the cavity 111 is negligible.

Therefore, the packaging cushion 1 protects the top surface 101a or the bottom surface of the household appliance 100 by using the first plate 10, and the side portion 11 provides targeted protection for the side surface 101c of the household appliance 100 close to the top or the bottom, which is beneficial to more reliable protection of the household appliance 100. When the household appliance 100 is inclined during handling, the cooperation of the side portion 11 and the first plate 10 can protect corners and edges of the top or the bottom of the household appliance 100 in an all-round way, thereby better preventing the household appliance 100 from impact and damage. Further, the side portion 11 is formed by folding of the flange of the first plate 10, that is, the side portion 11 and the first plate 10 are the same member, so that the packaging cushion 1 has a small quantity of parts and is easy to manufacture and assemble. Further, the cavity 111 of the side portion 11 is prevented from springback and deformation in the manner of filling the protective member 2, to ensure flat crush strength of the overall structure of the flange, thereby effectively protecting the periphery of the top or the bottom of the household appliance 100.

In a specific implementation, referring to FIG. 1 to FIG. 4, the side portion 11 at least partially extends around the first plate 10. Specifically, the side portion 11 may extend along three sides of the rectangular first plate 10, and respectively correspond to the pair of sidewalls and the rear wall of the main body 101 along the x direction. Therefore, at least part of the periphery of the top or the bottom of the household appliance 100 can be reliably protected.

In some embodiments, the side portion 11 may extend around two-thirds of the rim of the first plate 10, to protect most of the side surface 101c of the top or the bottom of the household appliance 100.

In a specific implementation, the rim on the at least one side of the first plate 10 may first extend along a first direction u and then extend back to the first plate 10 to form the cavity 111. A non-zero angle is formed between the first direction u and a plane in which the first plate 10 is located.

Specifically, the rim on the at least one side of the first plate 10 may be folded in a direction away from the first plate along the first direction u, and then folded back toward the center of the first plate 10 along an opposite direction of the first direction u until the rim abuts against the second surface 10b of the first plate 10. Therefore, the rim on the at least one side of the first plate 10 is folded in a manner that the second surface 10b faces inward to enclose the side portion 11 provided with the cavity 111.

Preferably, the first plate 10 is perpendicular to the z direction, the first direction u is parallel to the z direction, and an angle between the first direction u and the plane in which the first plate 10 is located may be 90°. In some embodiments, the angle between the first direction u and the plane in which the first plate 10 is located may be adapted to an angle between the top surface 101a and the side surface 101c. That is, the size of the angle between the side portion 11 and the first plate 10 may be flexibly adjusted based on the shape of the contour of the top or the bottom of the household appliance 100 that needs to be wrapped.

Therefore, the first plate 10 is self-folded to form the side portion 11, and an integral design is beneficial to reducing an assembly error and simplifying an assembly process. Further, the design of the cavity 111 enables the side portion 11 to have a particular thickness (a dimension in a direction from the center of the first plate 10 to the outside, that is, a dimension in the x direction or the y direction), so that when being impacted by an external force, the side portion 11 can serve the functions of cushioning and shock absorption, thereby better protecting the side surface 101c of the household appliance 100.

In a specific implementation, the protective member 2 and the first plate 10 are both made of a paper material. Therefore, manufacturing of the packaging cushion 1 using paper is beneficial to environmental protection while effectively protecting the top or the bottom of the household appliance 100. Further, the characteristic of the paper material enables the side portion 11 to be more easily folded and formed, thereby reducing processing difficulty of the packaging cushion 1 and facilitating manufacturing.

Further, the protective member 2 and the first plate 10 may be separately made of paper materials of different structures.

For example, the first plate 10 may be made of corrugated board. The corrugated board has features of easy formability, easy foldability, and puncture resistance, thereby facilitating quick folding to form the side portion 11.

For another example, the protective member 2 may be made of honeycomb board. Further, the honeycomb board may have a honeycomb structure with an array arrangement, and an axial direction of each honeycomb hole included in the honeycomb structure is perpendicular to the z direction. The side portions 11 located on a pair of side surfaces 101c that are opposite to each other in the x direction is used as an example. An axial direction of each honeycomb hole included in the protective member 2 filling the side portions 11 is parallel to the x direction, to provide reliable support in the x direction. The side portion 11 located on the side surface 101c on the rear side in the y direction is used as an example. The axial direction of each honeycomb hole included in the protective member 2 filling the side portion 11 is parallel to the y direction, to provide reliable support in the y direction.

Therefore, the protective member 2 and the first plate 10 are separately manufactured using more suitable paper materials, and can better achieve the functions of the components. For example, the first plate 10 is manufactured using an easily foldable paper material to facilitate the formation of the side portion 11, and a high-strength paper material is used as the protective member 2 to fill the cavity 111 to increase the flat crush strength of the side portion 11, thereby preventing the side portion 11 from being crushed and deformed when being impacted by an external force. Further, easy formability, easy foldability, and puncture resistance functions of the corrugated board are fully applied together with the honeycomb board having high flat crush strength, so that the manufactured packaging cushion 1 is aesthetically pleasing and environmentally friendly, and can effectively protect the top or the bottom of the household appliance 100.

In a specific implementation, strength of the protective member 2 may be greater than strength of the first plate 10. Therefore, the flat crush strength of the overall structure of the flange is ensured, thereby protecting the periphery of the top or the bottom of the household appliance 100 more effectively. For example, the protective member 2 and the first plate 10 are respectively made of paper materials of different structures, so that the strength of the protective member 2 is greater than the strength of the first plate 10. For another example, the protective member 2 and the first plate 10 may be made of paper materials of the same structure, and a difference lies in that the thickness (the dimension in the direction from the center of the first plate 10 to the outside) of the protective member 2 is greater than the thickness (the dimension in the direction from the first surface 10a to the second surface 10b) of the first plate 10. In this way, it can also be achieved that the strength of the protective member 2 is greater than the strength of the first plate 10.

In a specific implementation, rigidity of the protective member 2 may be greater than rigidity of the first plate 10. Therefore, the side portion 11 is less vulnerable to compression and deformation under the strengthening of the protective member 2, thereby better protecting the side surface 101c of the household appliance 100. For example, the protective member 2 may be made of a paper material with better rigidity, and the paper material used for the first plate 10 has a relatively low requirement on rigidity. The rigidity of the paper material may be measured based on parameters such as the structure and the density of the paper material.

In a specific implementation, compressive resistance of the protective member 2 may be greater than compressive resistance of the first plate 10. Therefore, the side portion 11 is not easily deformed when being pressed, thereby ensuring that the side surface 101c of the household appliance 100 is always reliably protected. For example, the protective member 2 and the first plate 10 are respectively made of paper materials of different structures, so that the compressive resistance of the protective member 2 is greater than the compressive resistance of the first plate 10. For another example, the protective member 2 and the first plate 10 may be made of paper materials of the same structure, and a difference lies in that the thickness of the protective member 2 is greater than the thickness of the first plate 10. In this way, it can also be achieved that the compressive resistance of the protective member 2 is greater than the compressive resistance of the first plate 10.

In a specific implementation, referring to FIG. 3, FIG. 5, and FIG. 7, the thickness of the protective member 2 may be greater than the thickness of the first plate 10. The thickness of the protective member 2 refers to a dimension of the protective member 2 in the direction from the center of the first plate 10 to the outside. For the protective member 2 covering a pair of sidewalls of the main body 101, the thickness of the protective member 2 refers to a dimension of the protective member 2 in the x direction. For the protective member 2 covering the rear wall of the main body 101, the thickness of the protective member 2 refers to a dimension of the protective member 2 in the y direction. The thickness of the first plate 10 refers to a dimension of the first plate 10 in the z direction.

For example, the thickness of the protective member 2 is not less than 20 millimeters (mm). Preferably, the thickness of the protective member 2 ranges from 24 millimeters to 25 millimeters.

For another example, the thickness of the first plate 10 may be 3 millimeters.

Therefore, the protective member 2 having a large thickness ensures that the side portion 11 is sufficiently thick to obtain good compressive resistance. Further, the first plate 10 should not have an excessively large thickness to ensure sufficient protection for the top surface 101a or the bottom surface, thereby facilitating folding to form the side portion 11.

In a specific implementation, referring to FIG. 1 to FIG. 7, the side portion 11 may include a first wall 11a and a second wall 11b that are opposite to each other and a third wall 11c located between the first wall 11a and the second wall 11b. The first wall 11a is connected to the first plate 10. An edge of the second wall 11b is positioned at the first plate 10. When the packaging cushion 1 wraps the top (or the bottom) of the household appliance 100, the first wall 11a is exposed, the second wall 11b is basically joined to the side surface 101c, and the third wall 11c faces downward (or upward).

Specifically, an assembly hole 13 may be opened in the first plate 10, an assembly portion 112 may be disposed at the edge of the second wall 11b, and the assembly portion 112 is configured to cooperate with the assembly hole 13 to position the second wall 11b to the first plate 10. For example, the assembly hole 13 may be a through hole opened in the first plate 10 and extending through the first surface 10a and the second surface 10b. The assembly portion 112 may be a protrusion protruding outward from the edge of the second wall 11b. As the rim of the first plate 10 is first folded along the first direction u and then folded back, the edge of the second wall 11b gradually approaches the first plate 10 until the protrusion is inserted into the corresponding through hole to implement positioning. Therefore, no additional fixing member is required, the first plate 10 is synchronously positioned when the rim of the first plate 10 is folded to form the side portion 11, and the process of forming the entire side portion 11 is simple and efficient.

Further, both a plurality of assembly holes 13 and a plurality of assembly portions 112 are provided, and are disposed at intervals in the extension direction of the second wall 11b. For example, referring to FIG. 10, the assembly holes 13 and the assembly portions 112 located at the rim on each side of the first plate 10 are equal in quantity and interval. In some embodiments, for the rim on each side, a quantity of assembly holes 13 and a quantity of assembly portions 112 that are disposed on the side may be determined based on the length (for example, the length of the second wall 11b) of the rim on the side. A larger length indicates a larger quantity of assembly portions 112 and a larger quantity of assembly holes 13 that are disposed (and/or smaller intervals).

In a specific implementation, cooperation between the assembly portion 112 and the assembly hole 13 can position the second wall 11b at the first plate 10 to some extent, thereby avoiding deformation of the side portion 11 due to unexpected springback of the flange. Considering that the length of the flange is large (the flange needs to extend beyond the entire side surface 101c), therefore, the protective member 2 is filled in the cavity 111, to avoid that cooperation between the assembly portion 112 and the assembly hole 13 is insufficient to resist springback and deformation of the entire flange during transportation and taking.

Specifically, the protective member 2 at least fills a space between the first wall 11a and the second wall 11b. The thickness of the protective member 2 may be substantially equal to a spacing between the first wall 11a and the second wall 11b, so that the protective member 2 fills the cavity 111 in a direction perpendicular to the first wall 11a as much as possible, thereby preventing detachment and springback of the assembly portion 112 of the second wall 11b from the assembly hole 13 to avoid deformation of the side portion 11.

Therefore, the protective member 2 fills at least a space between the initial segment (that is, the first wall 11a) and the tail segment (that is, the second wall 11b) of the flange of the first plate 10, to avoid deformation of the side portion 11 due to warping of the tail segment, thereby ensuring the reliability of protection for the side surface 101c by the side portion 11.

In some embodiments, a dimension of the protective member 2 in the z direction only needs to be not greater than the spacing between the third wall 11c and the first plate 10. Preferably, the dimension of the protective member 2 in the z direction may be equal to the spacing between the third wall 11c and the first plate 10. Therefore, when the packaging cushion 1 wraps the top of the household appliance 100, the protective member 2 can reliably fill the cavity 111 (especially, a region of the cavity 111 close to the first plate 10) without falling into a region of the cavity 111 away from the first plate 10 under the effect of gravity due to the small dimension in the z direction, thereby avoiding affecting a springback limiting effect on the side portion 11.

Certainly, an adhesive such as a paste may alternatively be used to fix the protective member 2 of a small size to the cavity 111 and preferentially fill the region of the cavity 111 close to the first plate 10, thereby reliably preventing the side portion 11 from springback and deformation during handling of the household appliance 100 in the packaged state.

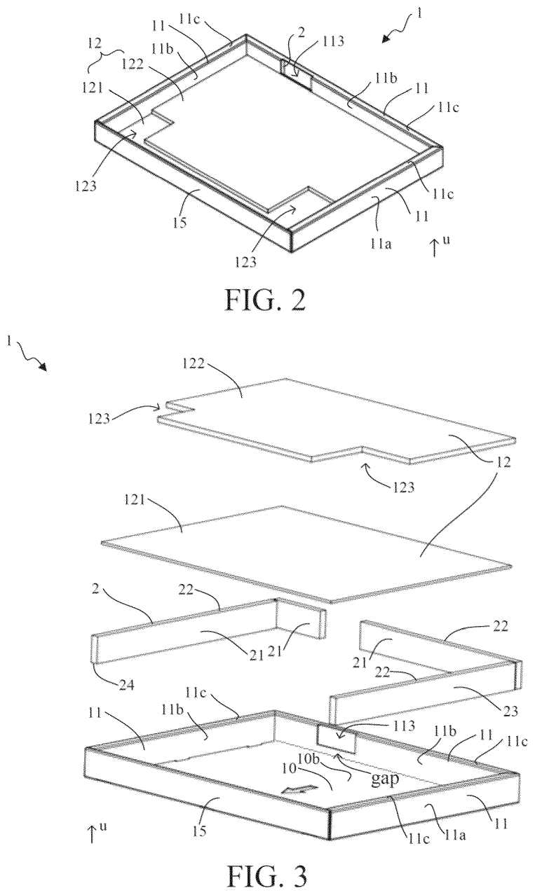

In a specific implementation, referring to FIG. 2 to FIG. 8, the packaging cushion 1 may further include a support plate 12, covering a face (that is, the second surface 10b) of the first plate 10 that faces the top surface 101a or the bottom surface of the main body 101, to increase the overall structural strength of the packaging cushion 1, thereby better protecting the top surface 101a or the bottom surface. Specifically, the shape of the support plate 12 may be adapted to the shape of the space of the first plate 10 that is enclosed by the side portion 11. For example, a region of the second surface 10b that is not covered by the side portion 11 is rectangular. Correspondingly, the support plate 12 is also rectangular with the same size.

Further, the second wall 11b may be partially sandwiched between the support plate 12 and the protective member 2. For example, referring to FIG. 7, the support plate 12 cooperates with the protective member 2 to clamp at least a part of the second wall 11b close to the first plate 10. In a direction from the center of the first plate 10 to the outside in a plane perpendicular to the z direction, the support plate 12 and the protective member 2 cooperatively clamp the second wall 11b from two sides, to prevent a positioning failure between an edge of the second wall 11b and the first plate 10, and prevent deformation of the side portion 11 caused by unexpected springback of the rim of the first plate 10 that forms the side portion 11.

Therefore, the flange forming the side portion 11 is prevented from springback and deformation through filling and support, thereby ensuring that the side portion 11 can effectively protect the periphery of the top or the bottom of the household appliance 100 all the time.

In a specific implementation, referring to FIG. 2 to FIG. 5, an avoidance groove 113 open toward a center of the first plate 10 may be opened in the side portion 11 and is configured to avoid a component located at the top or the bottom of the household appliance 100.

Specifically, components such as a water pipe and a control box of an ice maker may be provided at the top or the bottom of the household appliance 100. The arrangement positions of these components may cause the top or the bottom of the main body 101 to protrude outward in the plane perpendicular to the z direction. Correspondingly, the avoidance groove 113 is opened in the side portion 11 to avoid interference with components.

Further, the protective member 2 is disconnected at the avoidance groove 113. For example, the pair of side portions 11 opposite to each other in the x direction may be complete, and correspondingly, the protective members 2 filled in the cavities 111 of the two side portions 11 continuously extend along the y direction. Further, the component located at the top of the main body 101 partially protrudes backward along the y direction. Correspondingly, the avoidance groove 113 is provided in the side portion 11 corresponding to the rear wall of the main body 101. Two protective members 2 fill the cavity 111 of the side portion 11 and are disposed spaced apart in the x direction, and the interval corresponds to the avoidance groove 113.

Therefore, the design of the avoidance groove 113 ensures that the packaging cushion 1 does not interfere with inherent components of the household appliance 100 while providing reliable protection.

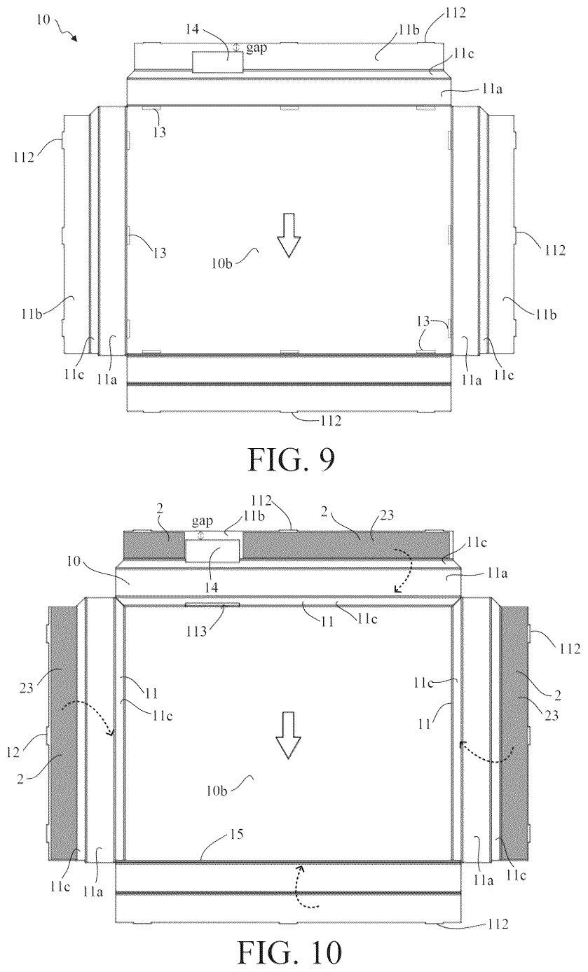

In a specific implementation, referring to FIG. 3, FIG. 9, and FIG. 10, a non-zero gap may be formed between the avoidance groove 113 and the edge of the second wall 11b. In other words, the avoidance groove 113 does not interrupt the tail segment of the side portion 11, and the second wall 11b provided with the avoidance groove 113 is still continuous end-to-end at the edge, so that the effect of preventing the side portion 11 from warping is better. Specifically, even if positioning of the edge of the second wall 11b between the partial section and the first plate 10 fails (for example, the assembly portion 112 is decoupled from the assembly hole 13), the second wall 11b may be roughly locked in place in cooperation with positioning of the other sections at the edge and the first plate 10, and the flange of the first plate 10 that forms the side portion 11 is not prone to springback and deformation.

Further, a height, in the z direction, of the non-zero gap that may be formed between the avoidance groove 113 and the edge of the second wall 11b may be substantially equal to a thickness (a dimension in the z direction) of the support plate 12. Therefore, it is ensured that the avoidance groove 113 is sufficiently large to avoid the components of the household appliance 100.

In some embodiments, the avoidance groove 113 may appear as a closed figure, for example, a rectangle. Therefore, the avoidance groove 113 is not opened to the bottom, and the edge of the second wall 11b forms a boundary on a side of the avoidance groove 113, thereby helping prevent the flange of the side portion 11 from springback and deformation.

In some embodiments, the avoidance groove 113 may be partially located in the second wall 11b and partially located in the third wall 11c. In other words, the avoidance groove 113 is a three-dimensional avoidance space provided in the side portion 11. Therefore, the avoidance groove 113 provides an avoidance space in a thickness direction (that is, a direction from the second wall 11b to the first wall 11a) of the side portion 11, thereby avoiding a component at the top or the bottom of the household appliance 100 more effectively.

In some embodiments, referring to FIG. 9 and FIG. 10, the avoidance groove 113 may be formed by a hollowed-out hole 14 opened in the rim on the side of the first plate 10 when the rim is folded to form the side portion 11. For example, part of the rim on the side of the first plate 10 may be cut out to form the hollowed-out hole 14. The hollowed-out hole 14 is partially opened in the second wall 11b and partially opened in the first wall 11a. The side portion 11 is formed as the rim is folded. The hollowed-out hole 14 naturally forms the avoidance groove 113 open toward the center of the first plate 10. Therefore, the avoidance groove 113 is formed at the same time when the side portion 11 is formed, thereby improving the manufacturing efficiency.

In a specific implementation, referring to FIG. 1 to FIG. 8, a rim on a side of the first plate 10 corresponding to the door 103 may be folded to form a blocking portion 15, and the blocking portion 15 covers part of a front surface 103a of the door 103. Specifically, the blocking portion 15 covers at least a region of the front surface 103a close to the upper surface 103b.

Further, a process of forming the blocking portion 15 may be similar to a process of forming the side portion 11. That is, the rim on the side of the first plate 10 that corresponds to the door 103 first extends along the first direction u, and is then folded back to extend to the first plate 10. In other words, the blocking portion 15 may alternatively be a double-layer protective structure formed by two first plates 10, and a difference between the blocking portion 15 and the side portion 11 lies in that a void 151 between the double-layer structure of the blocking portion 15 is negligible (for example, the two layers of corrugated paper forming the blocking portion 15 may be joined to each other), and the blocking portion 15 is not filled with the protective member 2.

Further, the double-layer protective structure formed by the blocking portion 15 covers the front surface 103a of the door 103. Therefore, the blocking portion 15 has better rigidity, strength, and compressive resistance, and can protect the front surface 103a of the door 103 more reliably.

Further, the blocking portion 15 and the side portion 11 are disposed around the first plate 10 in one circle, to cover the side surface 101c of the circle around the top surface 101a (or the bottom surface).

Therefore, the side portion 11 and the blocking portion 15 cooperate to better protect the periphery of the top or the bottom of the household appliance 100. Further, compression strength of the door 103 is usually better than that of the main body 101. Therefore, the protective member 2 may be properly eliminated from the blocking portion 15 corresponding to the door 103, to reduce the overall dimension of the household appliance 100 in the packaged state. The protective member 2 is preferably disposed for the side portion 11 of the main body 101, to increase the flat crush strength of the side surface of the packaging cushion 1, thereby better protecting the periphery of the top of the household appliance 100.

In some embodiments, the assembly portion 112 may alternatively be disposed at an end of the rim of the first plate 10 that forms the blocking portion 15, and the assembly hole 13 is correspondingly opened in the first plate 10. The assembly portion 112 and the assembly hole 13 cooperate to position the blocking portion 15 at the first plate 10.

In some embodiments, referring to FIG. 8, a void 151 may be formed inside the blocking portion 15, and a width of the void 151 is less than a width of the cavity 111. For example, the void 151 may be 4 mm wide, and the width of the cavity 111 may be 22 mm. The width refers to a spacing between two layers of corrugated paper.

The presence of the void 151 may be set in consideration of factors such as manufacturing convenience and the overall dimension requirement of the packaging cushion 1. Generally, a smaller void 151 of the blocking portion 15 is better, which helps increase the strength and/or the rigidity and/or the compressive resistance of the blocking portion 15. Further, the blocking portion 15 having a small void 151 can minimize the dimension of the refrigeration appliance 100 in the packaged state in the y direction based on the protection of the front surface 103a of the door 103.

In a specific implementation, referring to FIG. 6 to FIG. 8, a distance between the top surface 101a of the main body 101 and the first plate 10 may be greater than a distance between the upper surface 103b of the door 103 and the first plate 10. Specifically, the door 103 may protrude upward from the top surface 101a along the z direction, that is, the upper surface 103b is not flush with the top surface 101a.

Further, the thickness of the support plate 12 located between the first plate 10 and the top surface 101a may be greater than the thickness of the support plate 12 located between the first plate 10 and the upper surface 103b. Therefore, it is ensured that the first surface 10a is a complete large plane, which is beneficial to stable placement of the household appliance 100 in the packaged state.

Further, the door 103 is closer to the first plate 10, that is, compared with a large distance between the main body 101 and the connection between the side portion 11 and the first plate 10, the door 103 is closer to the connection between the blocking portion 15 and the first plate 10. Therefore, the door 103 itself may be used to abut against the blocking portion 15 to prevent the door 103 from springback and deformation.

Similarly, a distance between the bottom surface of the main body 101 and the first plate 10 is greater than a distance between the lower surface of the door 103 and the first plate 10. The door 103 is closer to the first plate 10, that is, compared with a large distance between the main body 101 and the connection between the side portion 11 and the first plate 10, the door 103 is closer to the connection between the blocking portion 15 and the first plate 10. Therefore, the door 103 itself may be used to abut against the blocking portion 15 to prevent the door 103 from springback and deformation.

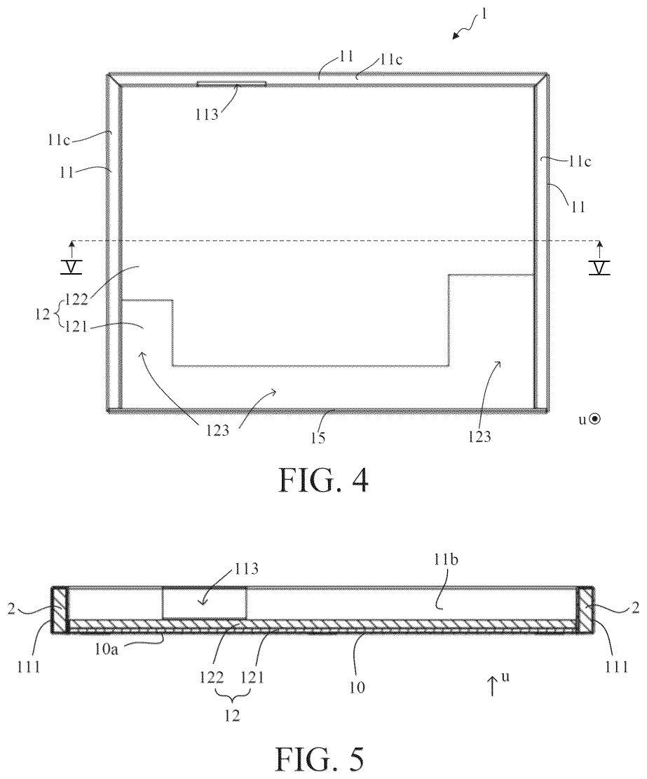

In a specific implementation, referring to FIG. 2, FIG. 4, and FIG. 8, the support plate 12 may abut against the side portion 11 in a circumferential direction to be limited to the side portion 11. For example, the dimension of the support plate 12 in the plane perpendicular to the z direction may be slightly greater than the dimension of a space of the first plate 10 that is jointly enclosed by the side portion 11 and the blocking portion 15, so that the support plate 12 is positioned in an interference fit in the space of the first plate 10 that is jointly enclosed by the side portion 11 and the blocking portion 15. In addition, the support plate 12 may apply a particular force to the second wall 11b, to cooperate with the protective member 2 to clamp the second wall 11b to prevent the second wall 11b from warping outward.

Therefore, the support plate 12 fills up the space enclosed by the side portion 11 and cooperates with the side portion 11 to implement positioning, so that auxiliary measures (for example, an adhesive tape) do not need to be used to fix the support plate 12 and the side portion 11, so that the packaging cushion 1 is environmentally friendly and has a more simplified manufacturing process.

In a specific implementation, strength of the support plate 12 may be greater than strength of the first plate 10. Therefore, the flat crush strength of the region of the packaging cushion 1 corresponding to the top surface 101a or the bottom surface is improved, so that the top or the bottom of the household appliance 100 can be better protected. For example, the support plate 12 and the first plate 10 are respectively made of paper materials of different structures, so that the strength of the support plate 12 is greater than the strength of the first plate 10. For another example, the support plate 12 and the first plate 10 may be made of paper materials of the same structure, and a difference lies in that the thickness (the dimension in the direction from the first surface 10a to the second surface 10b) of the support plate 12 is greater than the thickness (the dimension in the direction from the first surface 10a to the second surface 10b) of the first plate 10. In this way, it can also be achieved that the strength of the support plate 12 is greater than the strength of the first plate 10.

In a specific implementation, rigidity of the support plate 12 may be greater than rigidity of the first plate 10. Therefore, the region of the packaging cushion 1 corresponding to the top surface 101a or the bottom surface is not prone to deformation under pressure, thereby better protecting the top or the bottom of the household appliance 100. For example, the support plate 12 may be made of a paper material with better rigidity, and the paper material used for the first plate 10 has a relatively low requirement on rigidity. The rigidity of the paper material may be measured based on parameters such as the structure and the density of the paper material.

In a specific implementation, compressive resistance of the support plate 12 may be greater than compressive resistance of the first plate 10. Therefore, the compressive resistance of the top or the bottom of the household appliance 100 in a packaged state is enhanced. For example, the support plate 12 and the first plate 10 are respectively made of paper materials of different structures, so that the compressive resistance of the support plate 12 is greater than the compressive resistance of the first plate 10. For another example, the support plate 12 and the first plate 10 may be made of paper materials of the same structure, and a difference lies in that the thickness of the support plate 12 is greater than the thickness of the first plate 10. In this way, it can also be achieved that the compressive resistance of the support plate 12 is greater than the compressive resistance of the first plate 10.

In a specific implementation, referring to FIG. 5 to FIG. 8, the thickness of the support plate 12 may be greater than the thickness of the first plate 10. The thickness is a dimension in the z direction. For example, the thickness of the first plate 10 may be 3 millimeters. For another example, the thickness of the support plate 12 may range from 10 millimeters to 20 millimeters.

Therefore, the strength and the compressive resistance of the region of the packaging cushion 1 corresponding to the top surface 101a or the bottom surface are enhanced. Further, the combined thickness of the support plate 12 and the first plate 10 can increase the contact area with the side portion 11, so that the clamping and positioning effect on the second wall 11b in cooperation with the protective member 2 is more prominent.

In a specific implementation, referring to FIG. 2 to FIG. 8, the support plate 12 may include a second plate 121 and a third plate 122 that are sequentially arranged in a direction (for example, the z direction) perpendicular to the first plate 10, and the second plate 121 is located between the third plate 122 and the first plate 10. When the packaging cushion 1 wraps the top of the household appliance 100, the second plate 121 is sandwiched between the third plate 122 and the first plate 10, and the third plate 122 is sandwiched between the second plate 121 and the top surface 101a.

Further, the second plate 121 may fill up the region of the first plate 10 that is surrounded by the side portion 11 (and the blocking portion 15). That is, the second plate 121 may cover the top surface 101a and the upper surface 103b.

Further, the third plate 122 may fill a gap between the top surface 101a of the main body 101 and the first plate 10, or fill a gap between the bottom surface of the main body 101 and the first plate 10. Further, in the z direction, a face at which the third plate 122 and the second plate 121 are joined may be substantially flush with the upper surface 103b.

Therefore, the support plate 12 is further divided into the second plate 121 and the third plate 122. The second plate 121 preferably fills up the entire space enclosed by the side portion 11 (and the blocking portion 15) without considering the specific shape of the top surface 101a or the bottom surface (for example, whether the surface is bumpy due to the arrangement of components). On one hand, the strength/rigidity/compressive resistance of different positions of the first plate 10 can be enhanced, and on the other hand, the flange forming the side portions 11 can also be prevented from springback and deformation. Further, the third plate 122 is designed according to the specific shape of the top surface 101a or the bottom surface to fill in the void between the top surface 101a or the bottom surface and the second plate 121. The third plate 122 itself has a particular thickness to further stop the springback of the flange. On the other hand, the combination of the thicknesses of the third plate 122, the second plate 121, and the first plate 10 is conducive to further increasing the flat crush strength of the packaging cushion 1, thereby better protecting the top surface 101a or the bottom surface.

In some embodiments, the top surface 101a or the bottom surface of the main body 101 may be provided with a protrusion structure 104 protruding outward. The protrusion structure 104 may be, for example, a hinge, and the door 103 is movable connected to the main body 101 by the hinge. The protrusion structure 104 protrudes outward along the z direction from the top surface 101a or the bottom surface on which the protrusion structure 104 is located.

Further, the second plate 121 covers the protrusion structure 104. That is, the second plate 121 covers the entire top or bottom of the household appliance 100. The second plate 121 may directly contact the upper surface 103b.

Further, the third plate 122 forms a notch 123 corresponding to the protrusion structure 104. For example, referring to FIG. 2 to FIG. 4, the notch 123 is opened in each of regions of the third plate 122 that correspond to the hinge and the door 103.

Therefore, the second plate 121 and the first plate 10 jointly protect the entire top surface 101a or bottom surface, and the third plate 122 avoids the protrusion structure 104 while further improving the protection performance, thereby ensuring that the packaging cushion 1 can smoothly wrap the top or the bottom of the household appliance 100.

In a specific implementation, strength of the third plate 122 may be greater than strength of the second plate 121. Therefore, the flat crush strength of the region of the packaging cushion 1 corresponding to the top surface 101a or the bottom surface is improved, so that the top or the bottom of the household appliance 100 can be better protected. For example, the third plate 122 and the second plate 121 are respectively made of paper materials of different structures, so that the strength of the third plate 122 is greater than the strength of the second plate 121. For another example, the third plate 122 and the second plate 121 may be made of paper materials of the same structure, and a difference lies in that the thickness (the dimension in the direction from the first surface 10a to the second surface 10b) of the third plate 122 is greater than the thickness (the dimension in the direction from the first surface 10a to the second surface 10b) of the second plate 121. In this way, it can also be achieved that the strength of the third plate 122 is greater than the strength of the second plate 121.

In a specific implementation, rigidity of the third plate 122 may be greater than rigidity of the second plate 121. Therefore, the region of the packaging cushion 1 corresponding to the top surface 101a or the bottom surface is not prone to deformation under pressure, thereby better protecting the top or the bottom of the household appliance 100. For example, the third plate 122 may be made of a paper material with better rigidity, and the paper material used for the second plate 121 has a relatively low requirement on rigidity. The rigidity of the paper material may be measured based on parameters such as the structure and the density of the paper material.

In a specific implementation, compressive resistance of the third plate 122 may be greater than compressive resistance of the second plate 121. Therefore, the compressive resistance of the top or the bottom of the household appliance 100 in a packaged state is enhanced. For example, the third plate 122 and the second plate 121 are respectively made of paper materials of different structures, so that the compressive resistance of the third plate 122 is greater than the compressive resistance of the second plate 121. For another example, the third plate 122 and the second plate 121 may be made of paper materials of the same structure, and a difference lies in that the thickness of the third plate 122 is greater than the thickness of the second plate 121. In this way, it can also be achieved that the compressive resistance of the third plate 122 is greater than the compressive resistance of the second plate 121.

In a specific implementation, referring to FIG. 3 and FIG. 5 to FIG. 8, the thickness of the third plate 122 may be greater than the thickness of the second plate 121. For example, the thickness of the second plate 121 may be 7 millimeters, and the thickness of the third plate 122 may be determined based on a protrusion degree of the protrusion structure 104. The second plate 121 mainly serves the functions of assisting in strength improvement and preventing springback of the flange forming the side portion 11, and therefore has a relatively low requirement on the thickness. The third plate 122 is configured to fill the gap between the second plate 121 and the top surface 101a (or the bottom surface), and has a higher requirement on the thickness. Therefore, through the coordination of the second plate 121 having a small thickness and the third plate 122 having a large thickness, the overall height of the household appliance 100 in the packaged state is reduced while the effect of protecting the top surface 101a or the bottom surface is ensured, thereby facilitating handling.

In some embodiments, the second plate 121 may be made of corrugated board. Therefore, the second plate 121, the first plate 10, and the protective member 2 are all made of paper, and are environmentally friendly.

In some embodiments, the third plate 122 may be made of honeycomb board. An axial direction of each honeycomb hole included in the honeycomb structure of the honeycomb board is parallel to the z direction, to provide reliable support in the z direction. Therefore, the third plate 122 is made of honeycomb board having better strength, thereby further enhancing the effect of protecting the top or the bottom of the household appliance 100.

In a typical application scenario, a manufacturing process of the packaging cushion 1 may specifically include the following steps:

Step S1: Provide a first plate 10, as shown in FIG. 9. In this case, the first plate 10 may be in a fully expanded state, that is, a flat-laid state.

Step S2: Fix a protective member 2 to a rim on at least one side of the first plate 10, as shown in FIG. 10. To show the specific structure more clearly, in FIG. 10, a block filled in blue is used to represent the protective member 2. In this example, the protective member 2 is fixed to rims on the left, upper, and right sides of the viewing angle shown in the figure of the first plate 10.

Step S3: Fold the rim on the at least one side along a direction shown by a dashed line with an arrow in FIG. 10 to form a side portion 11, the protective member 2 being wrapped in a cavity 111 enclosed by the side portion 11. The eventually formed side portion 11 is also shown in a superimposed manner in FIG. 10.

Therefore, the manufacturing process of the packaging cushion 1 is simple, and production line production is more efficient. Specifically, the protective member 2 is folded together with the rim of the first plate 10, so that the action of inserting the protective member 2 into the cavity 111 is completed while the side portion 11 is formed. Compared with the manufacturing process of first forming the side portion 11 through folding and then inserting the protective member 2, the manufacturing process of this implementation solution involves fewer steps and achieves higher efficiency.

In some embodiments, step S2 may specifically include: fixing the protective member 2 to the rim on the at least one side against an edge of the first plate 10. That is, the protective member 2 is fixed to the rim of the first plate 10 against the edge of the second wall 11b. Further, the protective member 2 is joined to the second surface 10b. Therefore, before the rim of the first plate 10 is folded, the protective member 2 is fixed to a predetermined position of the first plate 10. During the folding, the protective member 2 can further play a positioning and guiding function, thereby facilitating quick and accurate folding to form the side portion 11.

In some embodiments, referring to FIG. 3 and FIG. 10, the protective member 2 may include a first face 21 fixed to the rim, an opposite third face 23, a second face 22 located between the first face 21 and the third face 23 and away from the edge of the first plate 10, and an opposite fourth face 24. Correspondingly, the first face 21 faces the second wall 11b, the second face 22 faces the third wall 11c, the third face 23 faces the first wall 11a, and the fourth face 24 faces the first plate 10.

Further, step S3 may specifically include:

S31: Fold the rim on the at least one side and the protective member 2 fixed to the rim from the edge of the first plate 10 toward a center of the first plate 10 until the second face 22 contacts the first plate 10.

S32: Continue to fold the rim on the at least one side toward the center of the first plate 10 (that is, fold the rim with an edge between the second face 22 and the third face 23 as the axis toward the center of the first plate 10) until the third face 23 contacts the first plate 10.

S33: Continue to fold the rim on the at least one side toward the center of the first plate 10 (that is, fold the rim with an edge between the third face 23 and the fourth face 24 as the axis toward the center of the first plate 10) until the fourth face 24 contacts the first plate 10.

S34: Position the edge of the first plate 10 (that is, the edge of the second wall 11b) to the first plate 10 to form the side portion 11 filled with the protective member 2.

Further, creases may be arranged in advance at the rim of the first plate 10 to facilitate folding. A spacing between the creases is adapted to the dimension of each face of the protective member 2.

Therefore, the shape of the cavity 111 in the side portion 11 formed by folding matches the shape of the outer contour of the protective member 2, so that the protective member 2 can fill the cavity 111 sufficiently, thereby effectively preventing the edge of the first plate 10 from springback and deformation.

Although specific implementation solutions have been described above, these implementation solutions are not intended to limit the scope of the present disclosure, even when only a single implementation solution is described with respect to specific features. Feature examples provided in the present disclosure are intended to be exemplary rather than limiting, unless indicated differently. In a specific implementation, technical features of one or more dependent claims may be combined with the technical features of the independent claims, and technical features from corresponding independent claims may be combined in any proper manner instead of only a particular combination enumerated in the claims.

Although the present disclosure is disclosed above, the present disclosure is not limited thereto. Any person skilled in the art can make various changes and modifications without departing from the spirit and scope of the present disclosure, and the scope of protection of the present disclosure should be as defined by the scope of the claims.

The following is a summary list of reference numerals and the corresponding structure used in the above description of the invention:
100 household appliance
101 main body
101a top surface
101c side surface
102 chamber
103 door
103a front surface
103b upper surface
104 protrusion structure
105 thermal insulation space
1 packaging cushion
10 first plate
10a first surface
10b second surface
11 side portion
11a first wall
11b second wall
11c third wall
111 cavity
112 assembly portion
113 avoidance groove
12 support plate
121 second plate
122 third plate
123 notch
13 assembly hole
14 hollowed-out hole
15 blocking portion
151 void
2 protective member
21 first face
22 second face
23 third face
24 fourth face
U first direction
Gap gap between the avoidance groove and an edge of the second wall
x width direction of the household appliance
y depth direction of the household appliance
z height direction of the household appliance

1. A packaging cushion for a household appliance, the household appliance having a main body defining a chamber and a door configured to close the chamber, the packaging cushion wrapping a top or a bottom of the household appliance, the packaging cushion comprising:
a first plate at least configured to cover a top surface or a bottom surface of the main body, said first plate having a rim on at least one side of said first plate being folded to form a side portion provided with a cavity, and said side portion being configured to cover at least part of a side surface of the main body; and
a protective member disposed in said cavity.

2. The packaging cushion according to claim 1, wherein:
said side portion extends at least partially around said first plate; and/or
said rim on said at least one side of said first plate first extends along a first direction and then extends back to said first plate to form said cavity, a non-zero angle being formed between the first direction and a plane in which said first plate is disposed; and/or
said protective member and said first plate are separately made of paper materials of different structures.

3. The packaging cushion according to claim 1, wherein:
a strength of said protective member is greater than a strength of said first plate; and/or
a rigidity of said protective member is greater than a rigidity of said first plate; and/or
a compressive resistance of said protective member is greater than a compressive resistance of said first plate; and/or
a thickness of said protective member is greater than a thickness of said first plate.

4. The packaging cushion according to claim 1, wherein:
said side portion has a first wall and a second wall that are opposite to each other and a third wall disposed between said first wall and said second wall;
said first wall is connected to said first plate;
said second wall has an edge positioned at said first plate; and
said protective member at least fills a space between said first wall and said second wall.

5. The packaging cushion according to claim 4, wherein:
said first plate has an assembly hole formed therein;
said second wall having an assembly portion disposed at said edge of said second wall; and
said assembly portion is configured to cooperate with said assembly hole to position said second wall to said first plate.

6. The packaging cushion according to claim 4, further comprising a support plate covering a face of said first plate that faces the top surface or the bottom surface of the main body, and said second wall being partially sandwiched between said support plate and said protective member.

7. The packaging cushion according to claim 4, wherein:
said side portion has an avoidance groove formed therein and open toward a center of said first plate and is configured to avoid a component located at the top or the bottom of the household appliance; and
said protective member is disconnected at said avoidance groove.

8. The packaging cushion according to claim 7, wherein:
a non-zero gap is formed between said avoidance groove and said edge of said second wall; and/or
said avoidance groove appears as a closed figure; and/or
said avoidance groove is partially disposed in said second wall and partially disposed in said third wall; and/or
said avoidance groove is formed by a hollowed-out hole opened in said rim on a side of said first plate when said rim is folded to form said side portion.

9. The packaging cushion according to claim 1, wherein a side of said first plate has a further rim corresponding to the door, said further rim is folded to form a blocking portion, and said blocking portion covers part of a front surface of the door.

10. The packaging cushion according to claim 9, wherein:
a void is defined inside said blocking portion, and a width of said void is less than a width of said cavity; and/or
a distance between the top surface of the main body and said first plate is greater than a distance between an upper surface of the door and said first plate; and/or
a distance between the bottom surface of the main body and said first plate is greater than a distance between a lower surface of the door and said first plate; and/or
said blocking portion forms a double-layer protective structure on the front surface of the door.

11. The packaging cushion according to claim 1, further comprising a support plate filling a region of said front plate that is surrounded by said side portion.

12. The packaging cushion according to claim 11, wherein:
said support plate abuts against said side portion in a circumferential direction to be limited to said side portion; and/or
a strength of said support plate is greater than a strength of said first plate; and/or
a rigidity of said support plate is greater than a rigidity of said first plate; and/or
a compressive resistance of said support plate is greater than a compressive resistance of said first plate; and/or
a thickness of said support plate is greater than a thickness of said first plate.

13. The packaging cushion according to claim 11, wherein said support plate includes a second plate and a third plate sequentially arranged along a direction perpendicular to said first plate, said second plate is disposed between said third plate and said first plate, said second plate fills up a region of said first plate that is surrounded by said side portion, and said third plate fills a gap between the top surface of the main body and said first plate or fills a gap between the bottom surface of the main body and said first plate.

14. The packaging cushion according to claim 13, wherein the top surface or the bottom surface of the main body is provided with a protrusion structure protruding outward, said second plate covers the protrusion structure, and said third plate forms a notch corresponding to the protrusion structure.

15. The packaging cushion according to claim 13, wherein:
a strength of said third plate is greater than a strength of said second plate; and/or
a rigidity of said third plate is greater than a rigidity of said second plate; and/or
a compressive resistance of said third plate is greater than a compressive resistance of said second plate; and/or
a thickness of said third plate is greater than a thickness of said second plate; and/or
said second plate is made of corrugated board; and/or
said third plate is made of a honeycomb board.

16. The packaging cushion according to claim 1, wherein:
said first plate is made of corrugated board; and/or
said protective member is made of honeycomb board; and/or
a cross section of said cavity is rectangular.

17. A household appliance being in a packaged state, comprising:
a main body defining a chamber; and
a door configured to close said chamber; and
the packaging cushion according to claim 1, wherein said first plate covers at least said top surface or said bottom surface of said main body, and said side portion covers part of a side surface of said main body.

18. A method for manufacturing a packaging cushion, the packaging cushion configured to wrap a top or a bottom of a household appliance, the method comprises:
providing a first plate;
fixing a protective member to a rim on at least one side of the first plate; and
folding the rim on the at least one side to form a side portion, the protective member being wrapped in a cavity enclosed by the side portion.

19. The manufacturing method according to claim 18, wherein the step of fixing the protective member to the rim on the at least one side of the first plate further comprises fixing the protective member to the rim on the at least one side against an edge of the first plate.

20. The manufacturing method according to claim 19, wherein the protective member contains a first face fixed to the rim, an opposite third face, a second face disposed between the first face and the third face and away from the edge of the first plate, and an opposite fourth face, and the step of folding the rim on the at least one side to form a side portion further comprises:
folding the rim on the at least one side and the protective member fixed to the rim from the edge of the first plate toward a center of the first plate until the second face contacts the first plate;
continuing to fold the rim on the at least one side toward the center of the first plate until the third face contacts the first plate;
continuing to fold the rim on the at least one side toward the center of the first plate until the fourth face contacts the first plate; and
positioning the edge of the first plate to the first plate to form the side portion filled with the protective member.
